(19) United States
(12) Patent Application Publication
(10) Pub. No.: US 2015/0175280 A1
(43) Pub. Date: Jun. 25, 2015

(54) BULK BAG DENSIFYING APPARATUS AND METHOD

(71) Applicant: Spiroflow Systems, Inc., Monroe, NC (US)

(72) Inventors: Jeffrey Allen Dudas, Waxhaw, NC (US); Jeffery J. Karigan, Mint Hill, NC (US)

(73) Assignee: Spiroflow Systems, Inc., Monroe, NC (US)

(21) Appl. No.: 14/136,320

(22) Filed: Dec. 20, 2013

(51) Int. Cl. B65B 1/22; B01F 3/18; B65B 1/24; B01F 11/00

(52) U.S. Cl. CPC B65B 1/22; B01F 11/0065; B01F 3/18; B65B 1/24

(57) ABSTRACT

An apparatus for densifying particulate contents of a bulk bag, that includes a support element and a pressure-applying element for supporting between them a bulk bag containing particulate contents with a pressure to the bag supplied by the pressure-applying element, and a vibrator carried by one or the other of the support element and the pressure-applying element for transmitting vibratory energy through the contents of the bag back and forth between the support element and the pressure applying element for densifying the contents of the bag and leveling a top surface of contents of the bag at a top end of the bag. A related method is also disclosed.

### TECHNICAL FIELD AND BACKGROUND OF THE INVENTION

The present invention relates to an apparatus and method for densifying the particulate contents of bulk bags of the type used in many industries to transport large quantities of products, such as pharmaceuticals, bulk chemicals, and food products in various grades of flowable powders and granulates. Bulk bags are typically made from woven polyester, polypropylene, or other polymer, may contain internal baffles and can typically hold between 2,000-4,000 pounds. The dimensions vary, but typical dimensions are about 42″×42″×42″, (107 cm) with an 18″ (46 cm) diameter spout that is about 16″ (41 cm) long at the center. In some cases the bag may be as tall as 90″ (229 cm). The shape of the bag is determined by the contents as they flow into the bag in order to achieve the nominal dimensions set out above. Generally, bulk bags have four loops, one in each corner at the top of the bag, that are used to lift and transport the bag with a lifting device such an overhead hoist or forklift, and to support the bag on a filling apparatus. Bulk bags are typically filled through a fill spout located in the top of the bag. The fill spout is secured, such as by tying a cord around the spout, after the fill is completed.

Filling is often facilitated by placing the bag on a vibrating base as its upper end is supported so as material flows into the bag, densification of the contents is promoted. However, this prior art process is less than satisfactory for several reasons. First, densification is incomplete, and as the bag fills the contents closest to the top of the bag do not fully densify because the contents closer to the bottom absorb some of the vibratory energy. Second, filling the bag from a filler spout causes the material in the center of the bag directly beneath the filler spout to mound up, forming a convex cone on the upper surface of the contents. In some instances filling the bag to about 41″ to 42″ (104-107 cm) in the center at the convex cone can result in a fill depth of several inches less that the height of the bag, for example, about 37″ (94 cm), around the sides of the bag. Present filling apparatuses do not adequately flatten this cone. The incomplete densification of the bag contents and the cone on the top surface of the contents reduces the amount of contents that can be placed in the bag, renders the sides of the bag somewhat deformable and permits shifting of the contents within the bag.

A more complete densification of the contents of bulk bags would therefore increase bag capacity, stabilize the contents, and provide a more uniform, rigid bag shape that is easier and safer to stack for shipment and storage.

### SUMMARY OF THE INVENTION

It is therefore an object of the present invention to provide greater densification of the contents of bulk bags in order to achieve increased bag capacity, stabilized contents, and a more uniform and rigid bag shape that is easier and safer to stack for shipment and storage.

These and other objects and advantages of the invention are achieved by providing an apparatus for densifying particulate contents of a bulk bag, including a support element and a pressure-applying element for supporting between them a bulk bag containing particulate contents with a pressure to the bag supplied by the pressure-applying element, and a vibrator carried by one or the other of the support element and the pressure-applying element for transmitting vibratory energy through the contents of the bag back and forth between the support element and the pressure applying element for densifying the contents of the bag and leveling a top surface of contents of the bag at a top end of the bag.

According to another embodiment of the invention, the support element includes a base on which a bottom side of the bag is supported and the pressure applying element includes a plate that applies pressure to a top side of the bag.

According to another embodiment of the invention, the support element includes a base on which a bottom of the bag is supported, the pressure applying element includes a plate that applies pressure to a top of the bag, and the vibrator is adapted to transmit vibratory energy to the base.

According to another embodiment of the invention, the pressure applying element includes a pressure plate and a pressure-applying apparatus adapted to reciprocate the pressure plate into a pressure applying position during vibration of the bag and a retracted position for placing the bag into and removing the bag from the apparatus.

According to another embodiment of the invention, the pressure-applying apparatus includes a pneumatic actuator.

According to another embodiment of the invention, two vibrators are provided to transmit vibratory energy, and further wherein the vibrators are adapted to oscillate in opposite directions for cancelling out side-to-side motion of the base.

According to another embodiment of the invention, a pair of spaced-apart pneumatic actuators are connected to the pressure plate at spaced-apart locations for controlling the movement of the pressure plate.

According to another embodiment of the invention, a pair of guide rods are mounted to the top pressure plate to guide the pressure plate in a fixed, vertical movement and relieve asymmetric stress on the pneumatic actuator.

According to another embodiment of the invention, an apparatus for densifying the particulate contents of a bulk bag is provided, and includes a base and a pressure-applying pressure plate for supporting between them a bulk bag containing particulate contents with a pressure to the bag supplied by the pressure plate, and a plurality of vibrators carried by the base for transmitting vibratory energy through the contents of the bag back and forth between the base and the pressure plate for densifying the contents of the bag and leveling a top surface of contents of the bag at a top end of the bag.

According to another embodiment of the invention, a pressure-applying pneumatic actuator is provided, and is adapted to reciprocate the pressure plate into a pressure applying position during vibration of the bag and a retracted position for placing the bag into and removing the bag from the apparatus.

According to another embodiment of the invention, two vibrators are provided to transmit vibratory energy, and are adapted to oscillate in opposite directions for cancelling out side-to-side motion of the base.

According to another embodiment of the invention, a method of densifying particulate contents of a bulk bag is provided, and includes the steps of applying pressure to opposed sides of the bulk bag containing particulate contents; and transmitting vibratory energy back and forth through the contents of the bag back and forth between the opposed sides for densifying the contents of the bag and leveling a top surface of contents of the bag at a top end of the bag.

According to another embodiment of the invention, the step of applying pressure to opposed sides of the bulk bag comprises applying pressure to a top side of the bag while the bag is supported on a base on which a bottom of the bag is supported.

According to another embodiment of the invention, the step of transmitting vibratory energy includes the step of transmitting vibratory energy to the base.

According to another embodiment of the invention, the method includes the step of vibrating the bag with two spaced-apart vibrators adapted to oscillate in opposite directions for cancelling out side-to-side motion of the base.

### BRIEF DESCRIPTION OF THE DRAWING FIGURES

The present invention is best understood when the following detailed description of the invention is read with reference to the accompanying drawings, in which:

FIG. 1 is a simplified side elevation of a bulk bag densifying apparatus, with the pressure plate in a raised, inoperative position;

FIG. 2 is a simplified side elevation of a bulk bag densifying apparatus, with the pressure plate in a lowered, operative position; and

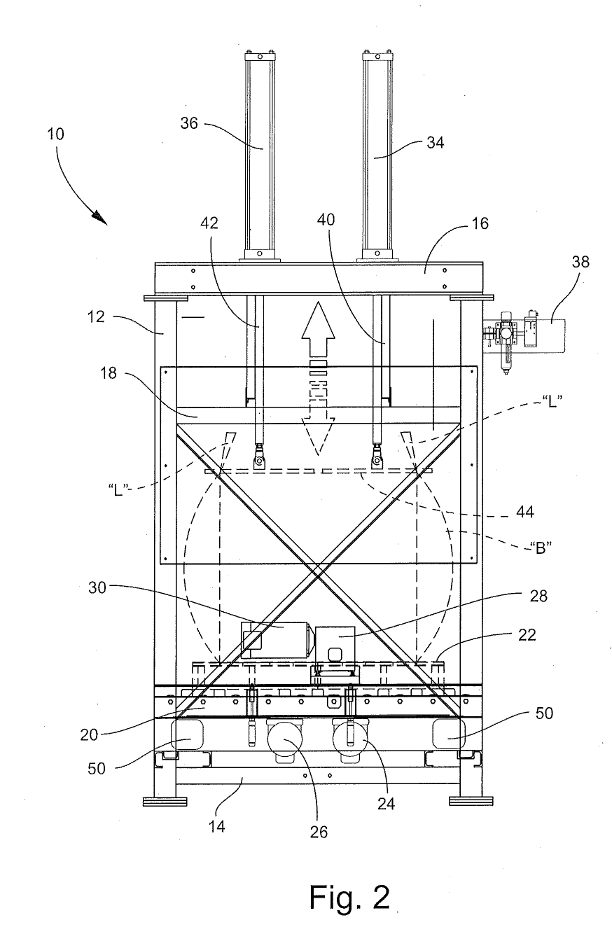

FIG. 3 is a simplified side elevation of a bulk bag densifying apparatus as in FIG. 1 with the pressure plate in a lowered, operative position.

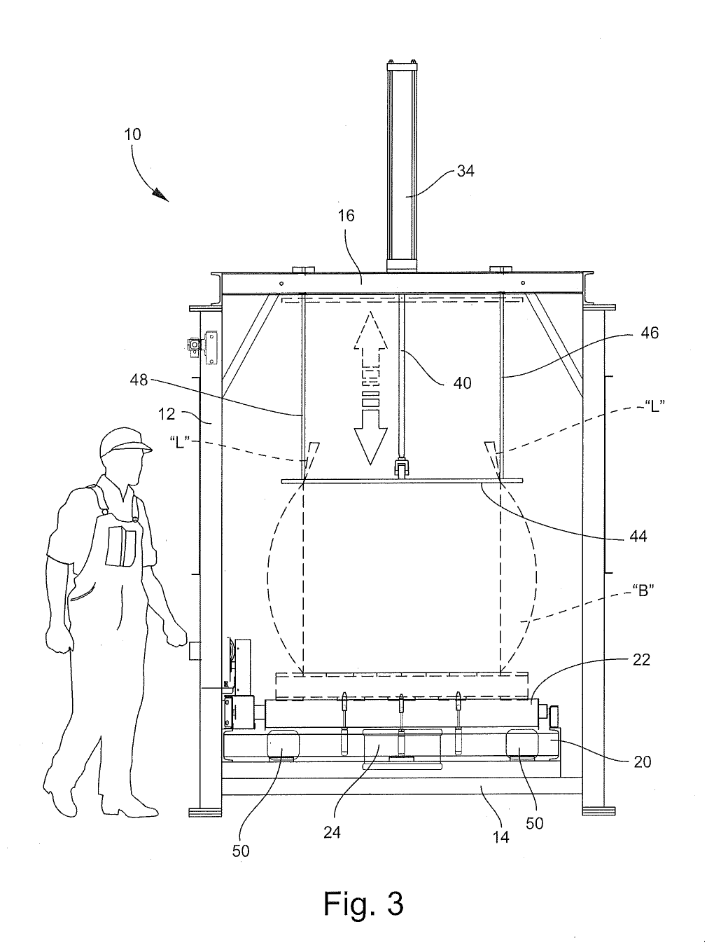

### DETAILED DESCRIPTION OF THE PREFERRED EMBODIMENT

Referring now specifically to the drawings, a bulk bag densifying apparatus is shown broadly at reference numeral 10. The apparatus 10 includes a rectangular frame 12 that includes a bottom frame element 14, a top frame element 16 and a bag positioning element 18 that includes hooks, not shown, that support the bag “B” by four loops “L” (two shown). Apparatus 10 includes a base frame element 20 on which is positioned a base 22. Preferably, a pair of vibrators 24 and 26 are mounted to the bottom of the base 22, driven by respective motors 28 and 30. It is preferable to have the vibrators 24, 26 vibrating in opposite oscillation directions to cancel out side-to-side motion. A single vibrator may suffice in some applications. The top surface of the base 22 is sized to support the bottom of a standard bulk bag “B” as it is supported and positioned by the loops “L”. The base 22 is preferably mounted on shock absorbing elements, such as air springs 50 mounted on the bottom frame element 14 that engage the bottom of the base 22. Other vibration isolating elements are also suitable.

The top frame element 16 carries a pair of pneumatic actuator assemblies 34, 36 driven by a pneumatic control 38. The cylinder rods 40, 42 extend downwardly and support a top pressure plate 44. Guide 46, 48 rods mounted to the top pressure plate 44 guide the pressure plate 44 in a fixed, vertical movement and relieve asymmetric stress on the cylinder rods 40, 42.

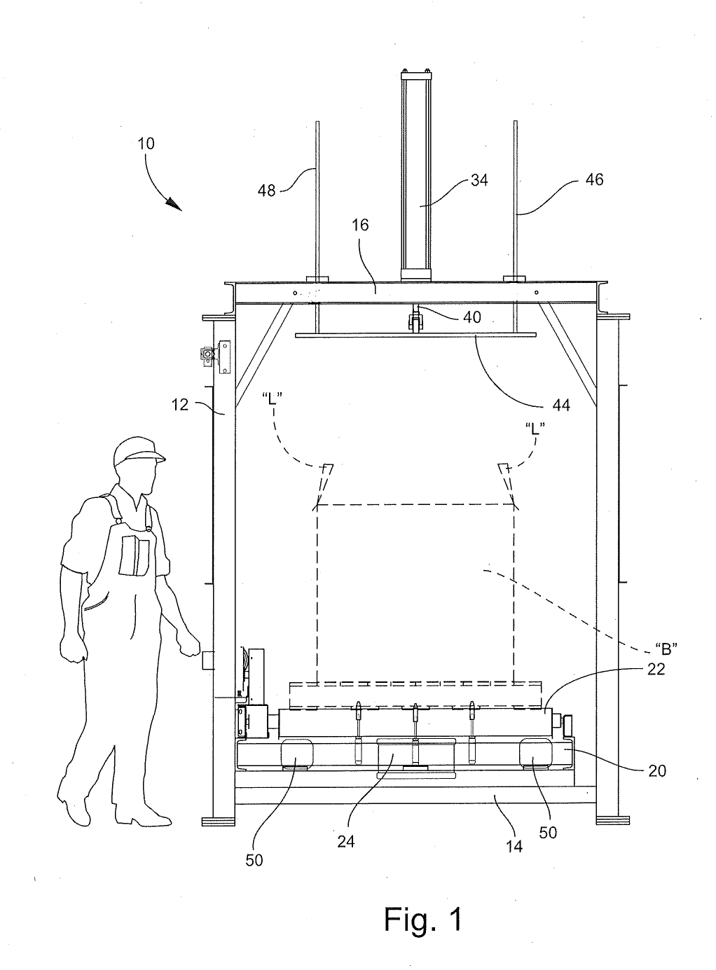

As shown in FIG. 1, the pressure plate 44 can be raised to the top of the apparatus 10 to permit the bag “B” to be placed on and removed from the base 22. While the apparatus 10 is shown and described as operating on a bag “B” that has been previously filled in a separate operation on a bag filling apparatus, the operating principles described can be used on either an apparatus 10 or on a bag filling machine equipped with the elements of the invention. In a bag filling machine, a bag “B” is supported on a base and vibrated while the top of the bag is held open and supported by loops. A filler spout conveys contents from another location and discharges it into the top of the bag.

In operation, a bag “B” is placed on the base 22, and the pressure plate 44 is lowered by the pneumatic actuators 34, 26 onto the top of the bag “B”. The pressure applied to the bag “B should be sufficient to firmly engage the center of the bag “B” where the raised cone resides. Then, the vibrators 24, 26 are activated. In contrast to the prior art, the vibratory energy from the vibrators 24, 26 flows through the bag contents and is reflected back through the bag contents by the pressure plate 44, instead of escaping. By pressurizing the bag “B” between the base 22 and the pressure plate 44, the vibratory energy has no escape path and instead is reflected back and forth through the bag contents. The result is a much greater densifying effect that flattens and spreads the top surface of the bag contents into the sides and corners, while the contents settle into the bag. The pressure plate 44 maintains pressure on the top of the bag contents as settling takes place and migrates the contents into a flattened top configuration is it vibrates. It has been determined that up to 5-6 percent additional material can be filled into a standard bulk bag using this new apparatus and method. In addition, the flattened top surface of the contents and greater rigidity of the bag side walls permit a bag “B” to be safely stacked on another bag “B” because of the extra stability offered by the flattened top. The amount of pressure applied to the bag is determined empirically and will vary depending on the type of material in the bag “B”.

The key operating principle is that the bag is trapped between a support element and a pressure-applying element with the bag contents under pressure between at least one vibrating surface and a vibration reflecting surface. For this reason, the vibrators can be positioned above the bag, with the bag being lifted up against the vibrators, or with the vibrators being lowered onto the top of the bag, while the weight of the “bag” itself on a base applies pressure to the bag contents. Similarly, the vibrators can be urged upwardly against the bottom of the bag while the pressure plate is held stationary.

A bulk bag densifying apparatus and method according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. An apparatus for densifying particulate contents of a bulk bag, comprising:
(a) a support element and a pressure-applying element for supporting between them a bulk bag containing particulate contents with a pressure to the bag supplied by the pressure-applying element; and
(b) a vibrator carried by one or the other of the support element and the pressure-applying element for transmitting vibratory energy through the contents of the bag back and forth between the support element and the pressure applying element for densifying the contents of the bag and leveling a top surface of contents of the bag at a top end of the bag.

2. An apparatus according to claim 1, wherein the support element comprises a base on which a bottom of the bag is supported and the pressure applying element comprises a plate that applies pressure to a top of the bag.

3. An apparatus according to claim 1, wherein the support element comprises a base on which a bottom of the bag is supported, the pressure applying element comprises a plate that applies pressure to a top of the bag, and the vibrator is adapted to transmit vibratory energy to the base.

4. An apparatus according to claim 3, wherein the pressure applying element comprises a pressure plate and a pressure-applying apparatus adapted to reciprocate the pressure plate into a pressure applying position during vibration of the bag and a retracted position for placing the bag into and removing the bag from the apparatus.

5. An apparatus according to claim 4, wherein the pressure-applying apparatus comprises a pneumatic actuator.

6. An apparatus according to claim 3, wherein two vibrators are provided to transmit vibratory energy, and further wherein the vibrators are adapted to oscillate in opposite directions for cancelling out side-to-side motion of the base.

7. An apparatus according to claim 5, wherein a pair of spaced-apart pneumatic actuators are connected to the pressure plate at spaced-apart locations for controlling the movement of the pressure plate.

8. An apparatus according to claim 7, and including a pair of guide rods mounted to the top pressure plate to guide the pressure plate in a fixed, vertical movement and relieve asymmetric stress on the pneumatic actuator.

9. An apparatus for densifying the particulate contents of a bulk bag, comprising:
(a) a base and a pressure-applying pressure plate for supporting between them a bulk bag containing particulate contents with a pressure to the bag supplied by the pressure plate; and
(b) a plurality of vibrators carried by the base for transmitting vibratory energy through the contents of the bag back and forth between the base and the pressure plate for densifying the contents of the bag and leveling a top surface of contents of the bag at a top end of the bag.

10. An apparatus according to claim 9, and including a pressure-applying pneumatic actuator adapted to reciprocate the pressure plate into a pressure applying position during vibration of the bag and a retracted position for placing the bag into and removing the bag from the apparatus.

11. An apparatus according to claim 9, wherein two vibrators are provided to transmit vibratory energy, and further wherein the two vibrators are adapted to oscillate in opposite directions for cancelling out side-to-side motion of the base.

12. A method of densifying particulate contents of a bulk bag, comprising:
(a) applying pressure to opposed sides of the bulk bag containing particulate contents; and
(b) transmitting vibratory energy back and forth through the contents of the bag back and forth between the opposed sides for densifying the contents of the bag and leveling a top surface of contents of the bag at a top end of the bag.

13. A method according to claim 12, wherein the step of applying pressure to opposed sides of the bulk bag comprises applying pressure to a top side of the bag while the bag is supported on a base on which a bottom side of the bag is supported.

14. A method according to claim 12, wherein the step of transmitting vibratory energy comprises the step of transmitting vibratory energy to the base.

15. A method according to claim 13, and including the step of vibrating the bag with two spaced-apart vibrators adapted to oscillate in opposite directions for cancelling out side-to-side motion of the base.
